(19) United States
(12) Patent Application Publication
(10) Pub. No.: US 2014/0167365 A1
(43) Pub. Date: Jun. 19, 2014

(54) WATER PROOF SEALING ASSEMBLY

(71) Applicant: Te-Yi CHU, New Taipei City (TW)

(72) Inventor: Te-Yi CHU, New Taipei City (TW)

(21) Appl. No.: 13/718,333

(22) Filed: Dec. 18, 2012

(51) Int. Cl. F16J 15/02

(52) U.S. Cl. CPC F16J 15/02
USPC 277/590

(57) ABSTRACT

A water proof sealing assembly includes a first part, a sealing member and a second part which is connected to the first part by two respective connection pieces. A recess is formed in one of the first part and the second part, and located close to the connection piece. The sealing member is located between the first and second parts. One end of the sealing member is inserted into the recess and compressed by the connection pieces.

### FIELD OF THE INVENTION

The present invention relates to a sealing assembly, and more particularly, to a water proof sealing assembly for preventing water from entering an object or an electronic object/element therein.

### BACKGROUND OF THE INVENTION

The conventional way to prevent water from entering the interior of an electronic object is to set a sealing member between the two parts of the case, and the sealing member is disclosed in Taiwan Patent Publication No. 1352270, and comprises a sealing ring and a fixing device. The case is composed of a top part and a bottom part, and the sealing member is located in the V-shaped groove defined in the bottom part. The sealing member has a fixing portion and a protrusion. The fixing device comprises a block and an engaging member respectively located on the top part and the bottom part. The protrusion of the sealing member is pressed into the V-shaped groove when the top and bottom parts are connected to each other.

However, the force generated due to the connection between the block and the engaging member is not sufficient for securely positioning the sealing member so that the sealing feature between the top and bottom parts is not satisfied.

The assembling time is increased when aligning the block and the engaging member, and engaging the block with the engaging member.

The block and the engaging member are easily broken when separating the top part and the bottom part, so that the conventional block and engaging member are not suitable for the two parts that are separated from and connected to each other frequently.

The present invention intends to provide a water proof sealing assembly which improves the shortcomings of the conventional one.

### SUMMARY OF THE INVENTION

The present invention relates to a water proof sealing assembly which comprises a first part, a sealing member and a second part.

The first part has a first connection portion and a first rib. The first connection portion is located along the periphery of the first part and the first rib is located at the inside of the first connection portion. A recess is defined between the first connection portion and the first rib.

The sealing member is located corresponding to the first connection portion of the first part and has a first pressing edge which extends an angle from the sealing member. The pressing edge is inserted into the recess.

The second part has a second connection portion which is located corresponding to the first connection portion of the first part. The second connection portion is located along the periphery of the second part and a second rib is located at the inside of the second connection portion. The second rib is inserted into the recess. The second rib has a first side engaged with the first rib. A second side of the second rib presses the pressing edge of the sealing member.

Preferably, a gap “S” is defined between the first connection portion of the first part and the second connection portion of the second part. The sealing member has a thickness “T” which is larger than the gap “S”.

Preferably, a stud extends from the inner end of the recess of the first part. The sealing member has an engaging hole defined in the pressing edge and the stud is engaged with the engaging hole.

Preferably, a distance “D” is defined between two insides of the recess of the first part. The second rib of the second part has a width “d”, and the pressing edge of the sealing member has a thickness “t”, wherein t+d>D.

Preferably, a hardness of the sealing member is lower than that of the first rib and the second rib.

Preferably, the first and second ribs are made by Nylon and the sealing member is made by Silicone.

Preferably, the first rib has a flange extending toward the outside of the first connection portion, and the second rib has a concave portion with which the flange is engaged.

Preferably, the first part and/or the second part have a passage and a cap is engaged with the passage. The cap has a space defined therein and a rod extends from the inner end of the space. A hardness of the rod is higher than that of the cap.

Preferably, the passage has a cone-shaped shoulder. The cap has a cone-shaped first protrusion and a cone-shaped second protrusion extending from outside thereof. The first and second protrusions respectively and partially clamp two sides of the shoulder. The diameter of the first protrusion is larger than the diameter of the passage.

The present invention further provides a water proof sealing assembly and comprises a first part, a sealing member and a second part. The second part is connected to a first rib of the first part by a second rib thereof. At least one recess is formed in one of the first part and located close to the first rib, or the at least one recess is formed in the second part and located close to the second rib. The sealing member is located between the first and second parts. One end of the sealing member is inserted into the recess and compressed by the first and second ribs.

Alternatively, the present invention provides a water proof sealing assembly and comprises a first part having a recess defined therein and a first engaging potion is formed on the inner periphery of the recess. A second part is engaged with the recess and has a second engaging portion which is engaged with the first engaging portion. A sealing member is mounted to the second part and located between the inner periphery of the recess and the second part.

Preferably, the first engaging portion of the first part is a concave portion and the second engaging portion of the second part is a convex portion.

The sealing member is compressed by the first and second ribs so as to achieve optimum sealing feature between the first part and the second part.

When the object is located in deep water, the water pressure compresses the central portion of the first and second parts and the central portions are slightly deformed to expand the first and second ribs so as to further compress the pressing edge of the sealing member to provide more water proof feature. The sealing level of IP (Ingress Protection) can reaches to IP66 to IP68.

The first and second ribs are connected to each other by the engagement of the flange and the concave portion, so that the connection is secured while is easily separated from each other. The first and second ribs are also durable and not easily broken.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the sealing assembly of the present invention;

FIG. 2 is a perspective view to show the sealing assembly of the present invention;

FIG. 3 is an exploded and cross sectional view of the sealing assembly of the present invention;

FIG. 4 is a cross sectional view to show that the sealing member is clamped between the first and second parts of the present invention;

FIG. 5 shows that the first rib pushes the second rib to compress the sealing member of the present invention;

FIG. 6 shows that the sealing member is positioned when the first part is connected to the second part;

FIG. 7 is a cross sectional view to show the connection of the first part and the sealing member of the present invention;

FIG. 8 is a perspective view to show the second embodiment of the present invention;

FIG. 9 is a cross sectional view to show the second embodiment disclosed in FIG. 8;

FIG. 10 is another cross sectional view to show the second embodiment disclosed in FIG. 8, and

FIG. 11 shows a cross sectional view of the third embodiment of the present invention.

### DETAILED DESCRIPTION OF THE PREFERRED EMBODIMENT

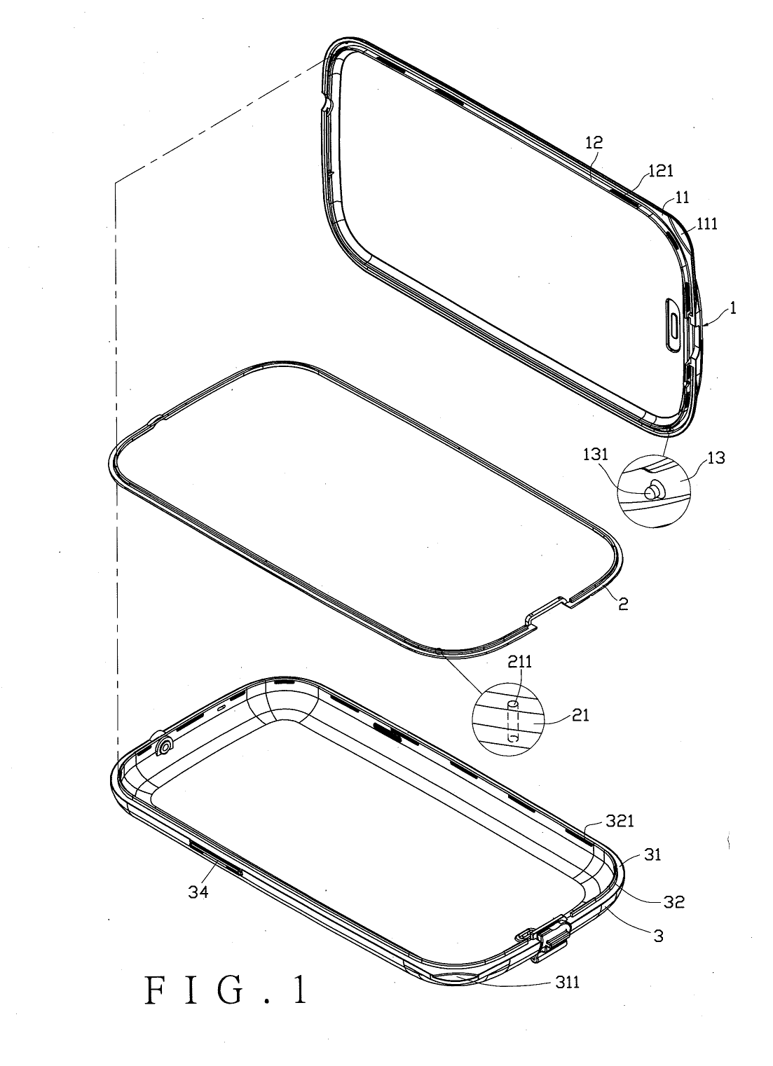

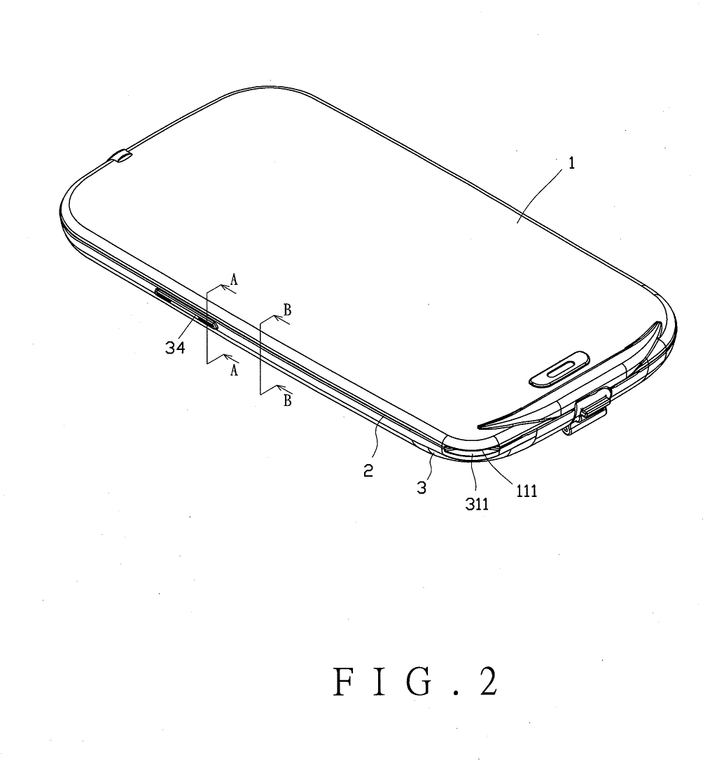

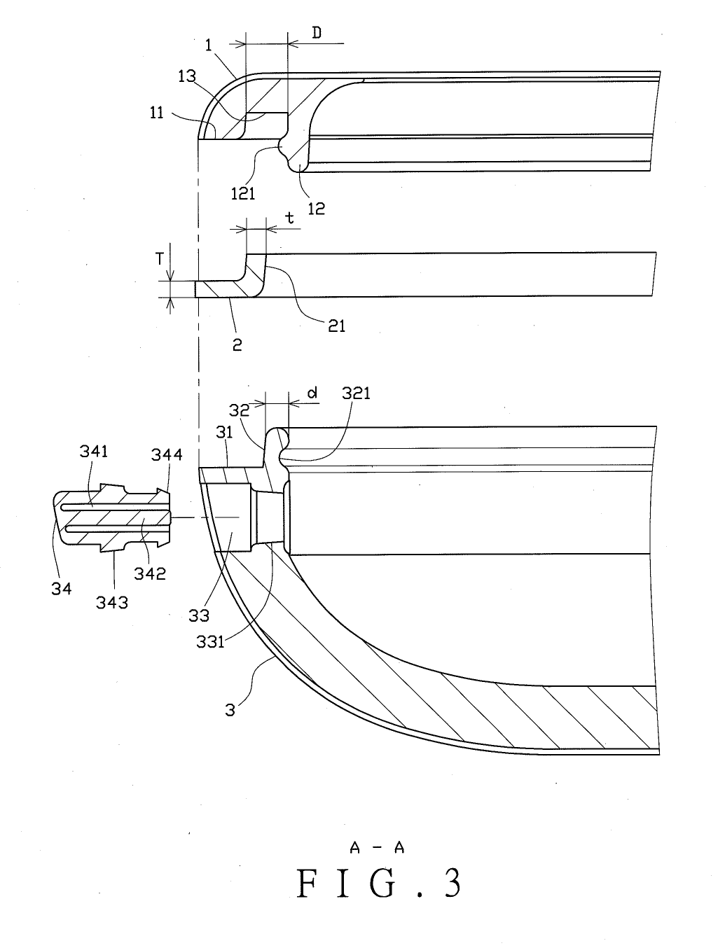

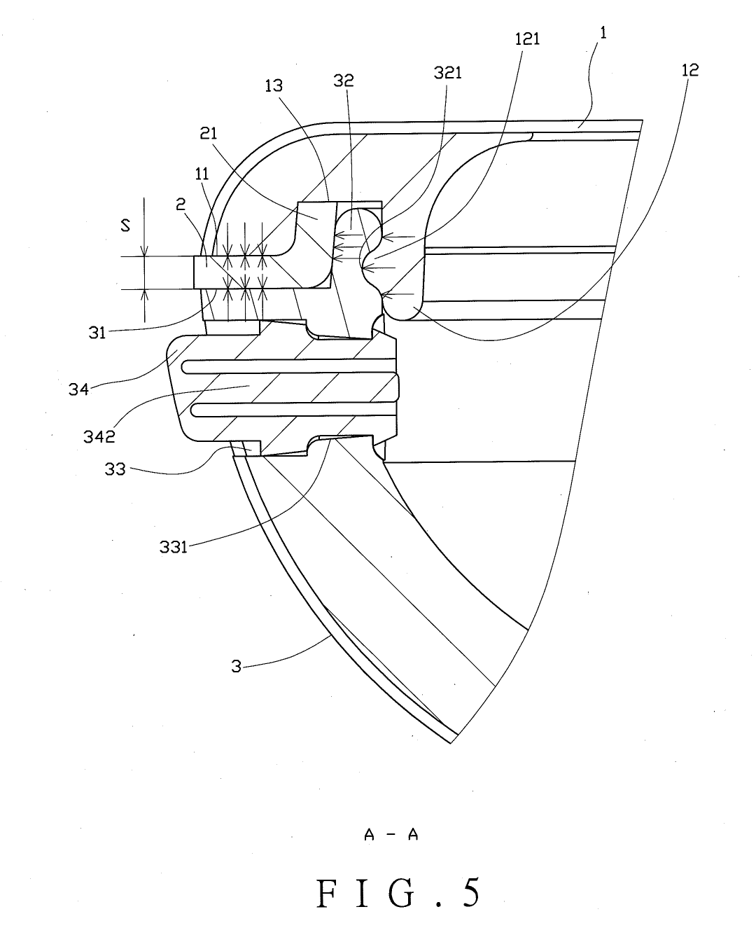

Referring to FIGS. 1 to 5, the water proof sealing assembly of the present invention comprises a first part 1 having a first connection portion 11 and a first rib 12. The first connection portion 11 has a lifting portion 111 on its corner. The first connection portion 11 is located along the periphery of the first part 1 and the first rib 12 is located at the inside of the first connection portion 11. The first rib 12 is made by durable plastic such as Nylon. The first rib 12 has multiple flanges 121 extending toward the outside of the first connection portion 11 (as shown in FIG. 3). A recess 13 is defined between the first connection portion 11 and the first rib 12. A distance “D” is defined between two insides of the recess 13 of the first part 1. A stud 131 (as shown in FIG. 1) extends from the inner end of the recess 13 of the first part 1.

A sealing member 2 is made by compressible, resilient and soft rubber such as Silicone, and located corresponding to the first connection portion 11 of the first part 1. The sealing member 2 has a thickness “T” and a pressing edge 21 extends an angle from the sealing member 2. The pressing edge 21 has a thickness “t” and is inserted into the recess 13. The sealing member 2 has multiple engaging holes 211 (as shown in FIG. 1) defined in the pressing edge 21, and the stud 131 is engaged with one of the engaging holes 211.

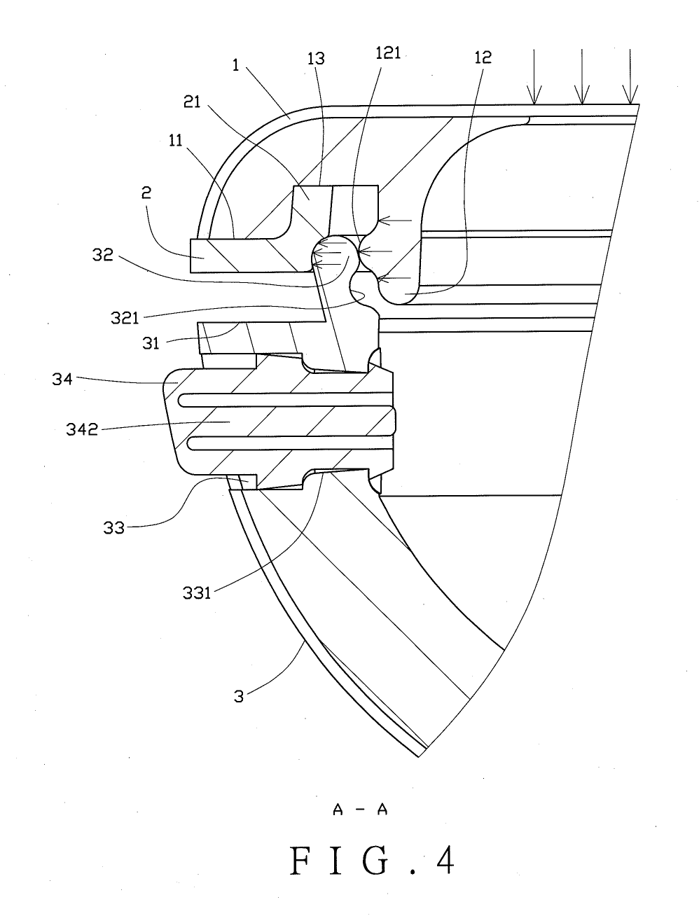

A second part 3 has a second connection portion 31 which is located corresponding to the first connection portion 11 of the first part 1 and has a notch 311 which is located corresponding to the lifting portion 111 (as shown in FIG. 1). A gap “S” (as shown in FIG. 4) is defined between the first connection portion 11 of the first part 1 and the second connection portion 31 of the second part 3. The thickness “T” of the sealing member 2 is larger than the gap “S”. The second connection portion 31 is located along the periphery of the second part 3 and a second rib 32 is located at the inside of the second connection portion 31. The second rib 32 is made by durable plastic such as Nylon. The second rib 32 of the second part 3 has a width “d” and the pressing edge 21 of the sealing member 2 has a thickness “t”, wherein t+d>D. The second rib 32 is inserted into the recess 13. The second rib 32 has multiple concave portions 321 with which the flanges 121 are engaged. The concave portions 321 are engaged with the flanges 121 by respective curved faces so as to compress the pressing edge 21 of the sealing member 2.

Further, the second part 3 has a passage 33 and a cone-shaped shoulder 331 extends from the inner periphery of the passage 33. A cap 34 is engaged with the passage 33 and the cap 34 is made by soft and resilient plastic. The cap 34 has a space 341 defined therein and a rod 342 extends from the inner end of the space 341. The hardness of the rod 342 is higher than that of the cap 34 so that when a user presses the cap 34, the rod 342 can compress a button of a product/object (not shown), such as a functional button of an electronic product, protected in the water proof sealing assembly.

The cap 34 has a cone-shaped first protrusion 343 and a cone-shaped second protrusion 344 extending from outside thereof. The first and second protrusions 343, 344 respectively and partially clamp two sides of the shoulder 331 to position the cap 34. The diameter of the first protrusion 343 is larger than the diameter of the passage 33 so that the cap 34 is snugly engaged with the inner periphery of the passage 33.

It is noted that the passage 33 and the cap 34 can be installed to at least one of the first part and the second part 3 so that the user can operate a protected object (not shown) in water.

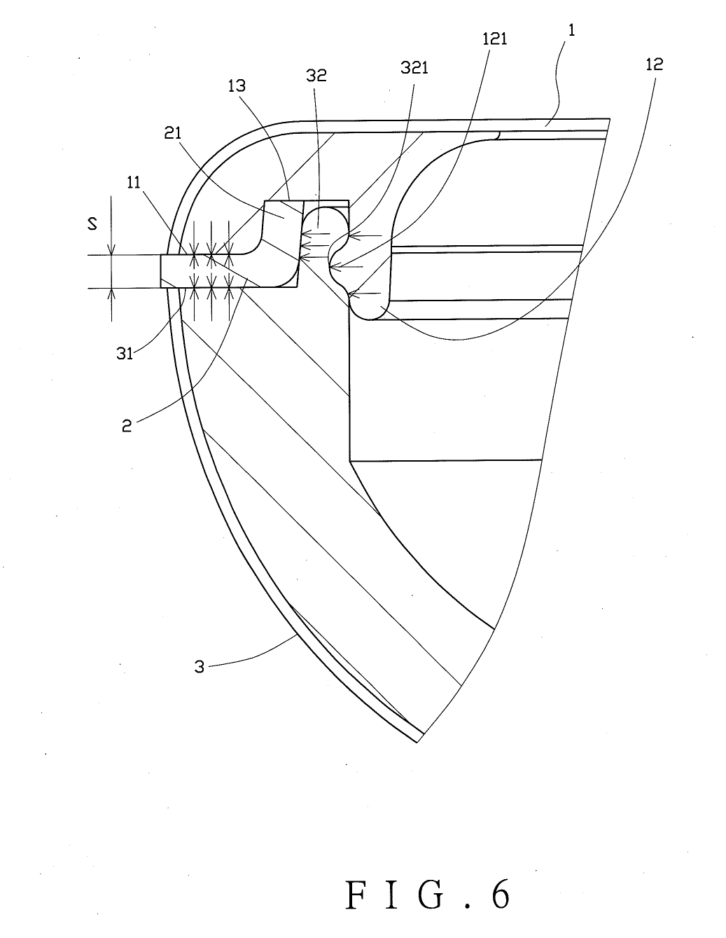

Further, as shown in FIG. 6, the structure of the water proof sealing assembly has better sealing effect without the cap 4.

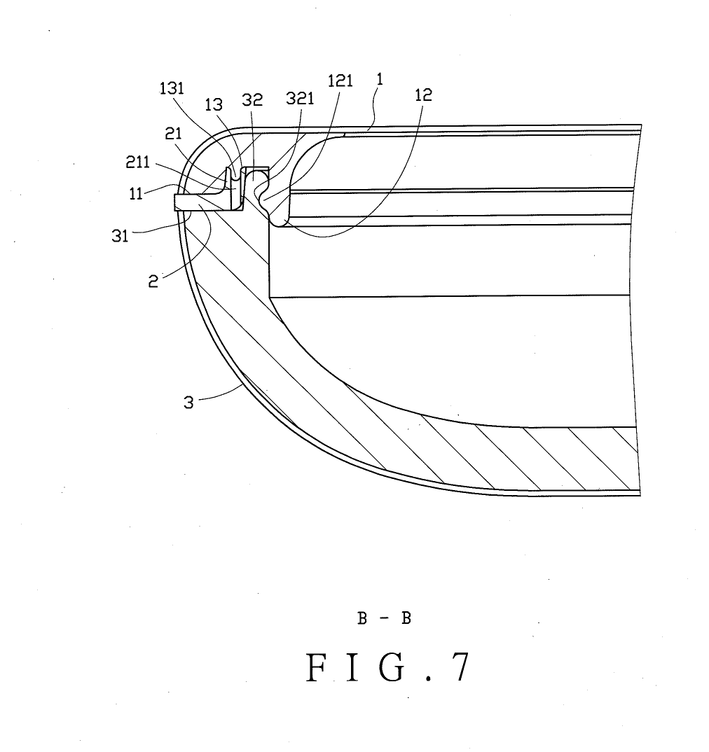

As shown in FIGS. 4 to 7, the present invention can also be used on different electronic objects such as the flat board computers, laptops and PDAs. Before use, the stud 131 of the first part 1 is engaged with the engaging hole 211 of the sealing member 2, such that the sealing member 2 is connected to the first part 1. The first part 1 is then mounted to the second part 3, and the second rib 32 is inserted into the recess 13. Concurrently, the concave portion 321 of the second rib 32 is engaged with the flange 121 of the first rib 12. When the first rib 12 is connected to the second rib 32, the first rib 12 pushes the second rib 32 which is then pushed toward the outside of the first connection portion 11 of the first part 1 to compress the pressing edge 21 of the sealing member 2. The engaging force between the first and second ribs 12, 32 let the first connection portion 11 and the second connection portion 31 to clamp the top and bottom of the sealing member 2. Therefore, the sealing member 2 is firmly compressed so that the sealing member 2 is snugly connected between the first and second parts 1, 2. Further, by firmly compressing sealing member 2, the connecting position between the first part 1 and the second part 3 is effectively sealed to prevent from water enter.

As shown in FIG. 6, when the water proof sealing assembly is in deep water, the water pressure compresses the two respective central portions of the first and second parts 1, 3 so that the central portions are slightly deformed to expand the first and second ribs 12, 32. The first and second connection portions 11, 31 are compressed inward to further compress the pressing edge 21 of the sealing member 2 to enhance water proof effect. The sealing level can reaches to IP66 to IP68.

Further, via the characteristic of the curve faces between the flange 121 and the concave portion 321, the flange 121 can be easily engaged with and disengaged from the concave portion 321, and such characteristic would also prevent the first and second ribs 12, 32 from being overly deformed during the engagement and disengagement of the first and second parts 1, 3. Hence, the curved faces between the flange 121 and the concave portion 321 allow the engagement and disengagement to be easily and conveniently, and are suitable for frequent assembling and disassembling circumstances for the present invention.

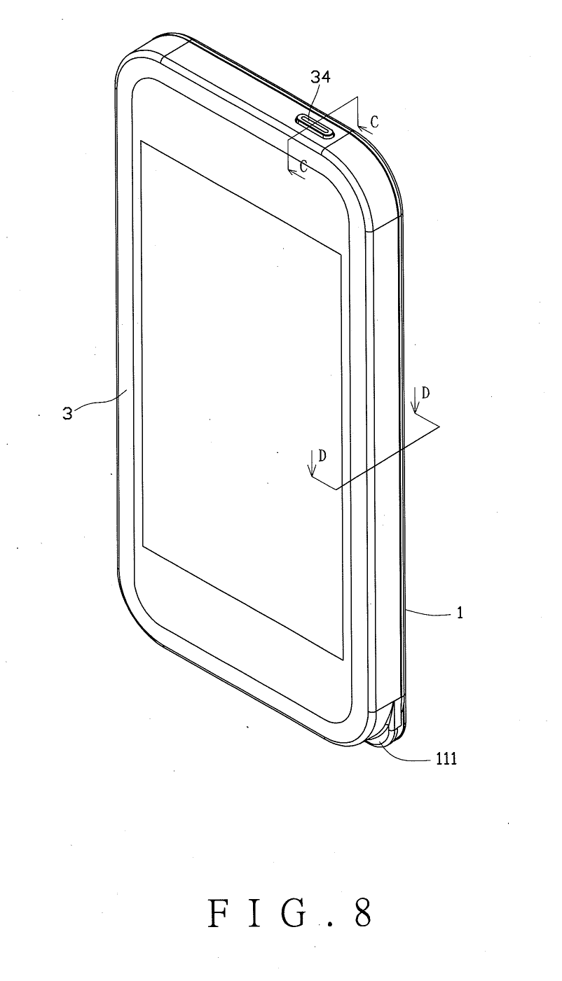

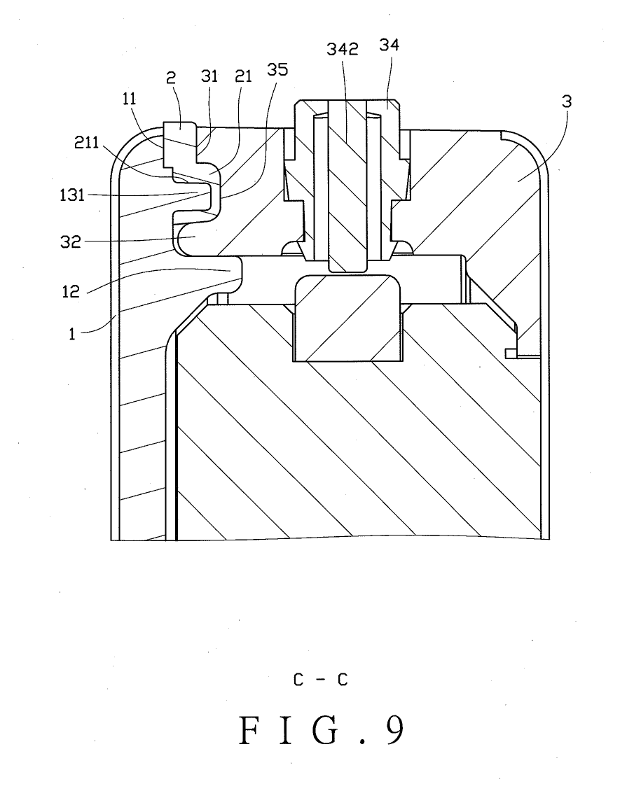

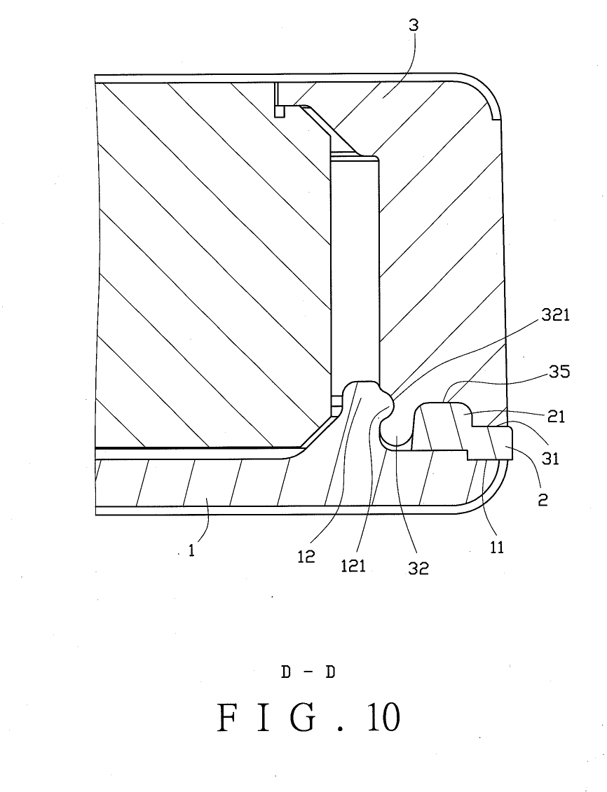

FIGS. 8 to 10 show the second embodiment, wherein the recess 35 can be alternatively installed to the second part 3 so as to accommodate the pressing edge 21 of the sealing member 2. Wherein, the second rib 32 compresses the pressing edge 21.

In other words, at least one of the first part 1 and the second part 3 has a recess 13/35 located close to the second rib 32 to compress the pressing edge 21 of the sealing member 2.

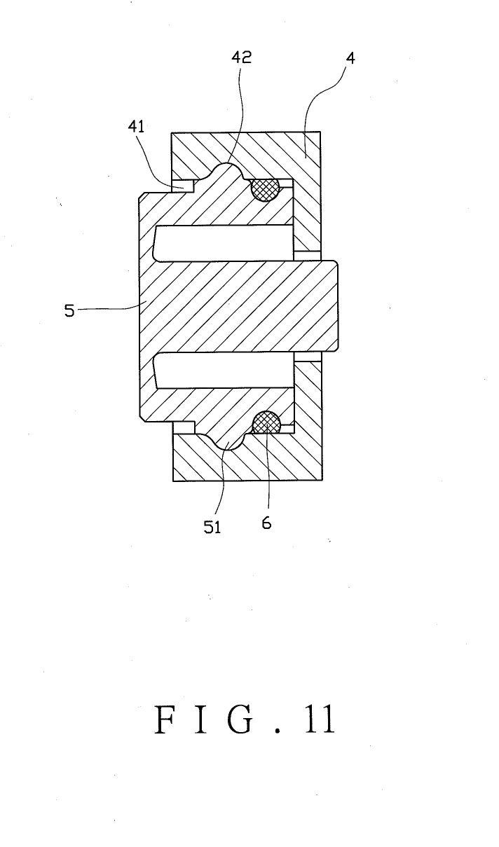

FIG. 11 shows the third embodiment and comprises a first member 4 having a hole 41 defined therein and a first engaging portion 42 is formed on the inner periphery of the hole 41. The first engaging portion 42 is a concave portion. Wherein, the first member 4 is a part of a combinable cover assembly, such as the first part 1 and the second part 3 of the first and second embodiment of the present invention. Alternatively, the first member 4 is an integrated cover/shell body.

A second member 5 can be a cap or a sound cap which is engaged with the hole 41 so that the user can touch a button of a product, such as the recorder, accommodated in the first member 4. The second member 5 has a second engaging portion 51 which is engaged with the first engaging portion 42. The second engaging portion 51 of the second member 5 is a convex portion. The first and second engaging portions 42, 51 is easily engaged with each other or disengaged from each other by the corresponding curved faces on the first and second engaging portions 42, 51.

A sealing portion 6 is mounted to the second member 5 and located between the inner periphery of the hole 41 and the second member 5 to increase the sealing effect between the first and second members 4, 5.

Preferably, the first member 4 is a part of the first part 1 or the second part 3.

Preferably, the hole 41 of the third embodiment can be seen as the passage 33 of the first and second embodiments.

Preferably, the sealing member 6 is close to the first engaging portion 42 or the second engaging portion 51.

Alternatively, the first engaging portion 42 is a convex portion, and the second engaging portion 51 is a concave portion.

While we have shown and described the embodiment in accordance with the present invention, it should be clear to those skilled in the art that further embodiments may be made without departing from the scope of the present invention.

What is claimed is:

1. A water proof sealing assembly comprising:
a first part having a first connection portion and a first rib, the first connection portion located along a periphery of the first part and the first rib located at an inside of the first connection portion, a recess defined between the first connection portion and the first rib;
a sealing member located corresponding to the first connection portion of the first part and having a first pressing edge which extends an angle from the sealing member, the pressing edge inserted into the recess, and
a second part having a second connection portion which is located corresponding to the first connection portion of the first part, the second connection portion located along a periphery of the second part and a second rib located at an inside of the second connection portion, the second rib inserted into the recess, the second rib engaged with the first rib, and the second rib compressing the pressing edge of the sealing member.

2. The sealing assembly as claimed in claim 1, wherein a gap is defined between the first connection portion of the first part and the second connection portion of the second part, and the sealing member has a thickness which is larger than the gap between the first connection portion of the first part and the second connection portion of the second part.

3. The sealing assembly as claimed in claim 1, wherein a stud extends from an inner end of the recess of the first part, the sealing member has an engaging hole defined in the pressing edge, and the stud is engaged with the engaging hole.

4. The sealing assembly as claimed in claim 1, wherein a distance “D” is defined between two insides of the recess of the first part, the second rib of the second part has a width “d”, the pressing edge of the sealing member has a thickness “t”, and t+d>D.

5. The sealing assembly as claimed in claim 1, wherein a hardness of the sealing member is lower than that of the first rib and the second rib.

6. The sealing assembly as claimed in claim 5, wherein the first and second ribs are made by Nylon and the sealing member is made by Silicone.

7. The sealing assembly as claimed in claim 1, wherein the first rib has a flange extending toward an outside of the first connection portion, the second rib has a concave portion with which the flange is engaged.

8. The sealing assembly as claimed in claim 1, wherein the first part and/or the second part have a passage and a cap is engaged with the passage, the cap has a space defined therein, a rod extends from an inner end of the space, and a hardness of the rod is higher than that of the cap.

9. The sealing assembly as claimed in claim 8, wherein the passage has a cone-shaped shoulder, the cap has a cone-shaped first protrusion and a cone-shaped second protrusion extending from outside thereof, the first and second protrusions respectively and partially clamp two sides of the shoulder, and a diameter of the first protrusion is larger than a diameter of the passage.

10. A water proof sealing assembly comprising:
a first part, a sealing member and a second part, wherein a first rib located on the first part is engaged with a second rib located on the second part, at least one recess formed in the first part and located close to the first rib or formed in the second part and located close to the second rib, the sealing member is located between the first and second parts, and one end of the sealing member is inserted into the recess and compressed by the first and second ribs.

11. A water proof sealing assembly comprising:
a first member having a hole defined therein and a first engaging portion formed on an inner periphery of the hole;
a second member engaged with the hole and having a second engaging portion which is engaged with the first engaging portion, and
a sealing member mounted to the second member and located between the inner periphery of the hole and the second member.

12. The sealing assembly as claimed in claim 11, wherein the first engaging portion of the first part is one of a concave portion and a convex portion, and the second engaging portion of the second part is the other of the concave portion and the convex portion.
